(19) United States
(12) Patent Application Publication
(10) Pub. No.: US 2025/0260433 A1
(43) Pub. Date: Aug. 14, 2025

(54) COMMUNICATION WITHIN AN ELECTRONIC DEVICE

(71) Applicant: STMicroelectronics International N.V., Geneva (CH)

(72) Inventors: Alexandre TRAMONI, Le Beausset (FR); Nicolas DEMANGE, Saint-Maximin la Sainte Baume (FR)

(73) Assignee: STMicroelectronics International N.V., Geneva (CH)

(21) Appl. No.: 19/049,374

(22) Filed: Feb. 10, 2025

(30) Foreign Application Priority Data
Feb. 14, 2024 (FR) FR2401418

(51) Int. Cl. H04B 1/3816

(52) U.S. Cl. CPC H04B 1/3816

(57) ABSTRACT

An embedded secure element (eSE) includes an input configured to receive a first data signal and an output configured to deliver a second signal. The eSE further includes a circuit configured to implement an embedded SIM card. The output is intended to be coupled to an external SIM card. A selector within the eSE receives the first signal from the input is controlled in a first selection to deliver the first signal to the embedded SIM card. The selector is further controlled in a second selection to deliver the first signal to a voltage level converter which level shifts the first signal to generate the second signal at the output.

### PRIORITY CLAIM

This application claims the priority benefit of French Application for Patent No. 2401418, filed on Feb. 14, 2024, the content of which is hereby incorporated by reference in its entirety to the maximum extent allowable by law.

### TECHNICAL FIELD

The present disclosure generally concerns electronic systems and devices and the power supply and the transmission of signals within these electronic systems and devices. The present disclosure more specifically concerns the adaptation of voltage levels within a complex electronic system or device.

### BACKGROUND

Complex electronic systems and devices may be formed of a plurality of circuits, modules, or subsystems, using different voltage levels. The use of voltage level adaptation circuits is thus necessary for the correct operation of this type of electronic system or device.

It would be desirable to be able to improve, at least partly, certain aspects of the management of voltage levels within an electronic system or device.

There exists a need for electronic systems and devices having a better management of the voltage levels used by the circuits and modules forming them.

There exists a need for more compact electronic systems and devices.

There is a need in the art to overcome all or part of the disadvantages of known circuits and processes for management of different voltage levels within an electronic system or device.

### SUMMARY

An embodiment provides an electronic system or device comprising an embedded secure element itself comprising a level converter circuit configured to adjust the voltage levels of signals intended for a SIM card.

An embodiment provides an embedded secure element comprising: at least one input configured to receive at least a first data signal; a circuit configured to implement an embedded SIM card; at least one output configured to deliver a second signal; a first voltage level converter configured to deliver said second signal to said output; and a selector configured to receive said first signal and to deliver it either to said circuit or to said output according to a control signal.

According to an embodiment, said output is configured to deliver said second signal to a first slot intended for a first SIM card.

According to an embodiment, said first voltage level converter is bidirectional.

According to an embodiment, said first voltage level converter comprises: an input node; an output node; a first branch, coupling said input node to said output node, comprising a first delay circuit and a first voltage level step-up circuit; and a second branch, coupling the output node to said input node, comprising a second delay circuit and a second voltage level step-up circuit.

Another embodiment provides a chip comprising a previously-described embedded secure element.

According to an embodiment, the chip further comprises a near-field communication controller.

Another embodiment provides an electronic device comprising a previously-described chip, a router, and said first slot.

According to an embodiment, the device further comprises a second slot intended for a second SIM card.

According to an embodiment, the device further comprises a second voltage level converter coupling said router and said second slot.

According to an embodiment, the device is a cell phone.

Another embodiment provides a method of communication within the previously-described device between said router and said first slot.

According to an embodiment, the method comprises the following successive steps: sending a control signal to said selector indicating that said first slot is selected; sending, by use of said router, said first voltage to the input of said embedded secure element; converting said first voltage, by use of said first voltage level converter, into said second voltage; and sending, by use of said embedded secure element, said second voltage to said first slot.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 very schematically shows in the form of blocks an embodiment of an electronic device;

FIG. 2 shows in further detail the embodiment of FIG. 1;

FIG. 3 shows a level converter circuit; and

FIG. 4 shows timing diagrams illustrating the operation of the circuit of FIG. 3.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

The embodiments described hereafter concern complex electronic systems and devices, and more particularly the transmission of signals within such electronic systems and devices. The embodiments more particularly relate to the use of one or a plurality of subscriber identity/identification module (SIM) cards and of one or a plurality of SIM cards embedded in such electronic systems or devices. A SIM card is an electronic device, generally a chip equipped with at least one microprocessor and data storage circuit, carrying the identity of a user. An embedded SIM (eSIM) card, is a software device carrying the identity of a user, and can be implemented by a circuit comprising, for example, a processor and data storage circuit.

There exist electronic systems or devices capable of implementing a plurality of SIM cards and/or embedded SIM cards. Not all SIM cards and embedded SIM cards are configured to receive signals referenced to the same voltage levels. The embodiments described hereafter provide supplying a compact electronic device in which SIM cards and embedded SIM cards receive signals having adjusted voltage levels.

Further, the embodiments described hereafter are particularly applicable to electronic systems and devices using SIM cards and embedded SIM cards, such as cell phones or smart cell phones, connected tablets, or any other connected objects capable of using a SIM card.

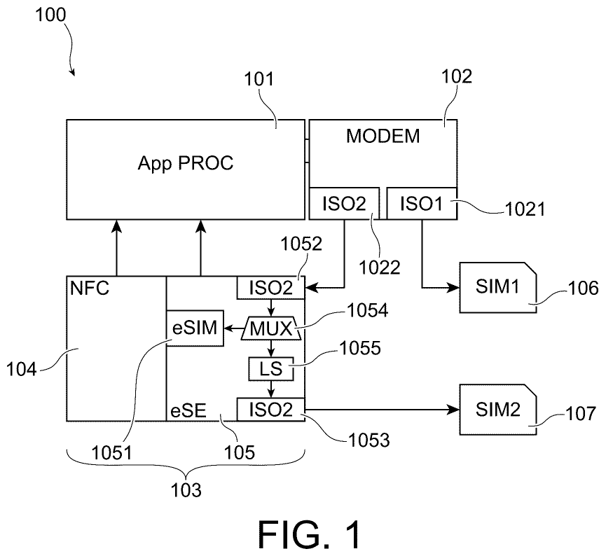

FIG. 1 schematically shows in the form of blocks an embodiment of an electronic device 100.

According to an example, electronic device 100 comprises a processor 101 (App Proc), for example a processor configured to implement application functions.

Device 100 further comprises a router 102 (Modem) configured to transmit signals within device 100. According to an example, router 102 can exchange signals with processor 101. According to an embodiment, router 102 comprises at least two terminals 1021 (ISO1) and 1022 (ISO2). The data signals supplied by router 102 are all referenced to a first voltage level Vdd1.

Device 100 further comprises a chip 103 configured to communicate with processor 101 and/or router 102.

Chip 103 optionally comprises a circuit configured to implement a communication function 104 (NFC). According to a preferred example, circuit 104 is configured to implement a near field communication (NFC) circuit 104 and is, in this case, also referred to as an NFC controller 104.

According to an embodiment, chip 103 comprises an embedded secure element (eSE) 105 configured to implement secure operations. Element 105 generally comprises its own processor(s), its own memory or memories, and/or its own circuit(s) implementing various functions. In the embodiment described herein, embedded secure element 104 comprises at least one circuit 1051 (eSIM) configured to implement an embedded SIM card. As previously mentioned, circuit 1051 may comprise a processor and a data storage circuit.

Embedded secure element 105 further comprises at least two communication terminals 1052 (ISO2) and 1053 (ISO2), a selector circuit 1054 (MUX or multiplexer), and a voltage level converter 1055 (LS or level shifting circuit), the uses of which are described hereafter. Selector 1054 comprises an input coupled, preferably connected, to terminal 1052, a control terminal receiving a control signal, not shown in FIG. 1, and at least two outputs, one being coupled to circuit 1051 (and selected by a first state of the control signal) and the other being coupled to an input of voltage level converter 1055 (and selected by a second state of the control signal). An output of converter 1055 is coupled, preferably connected, to terminal 1053.

According to an embodiment, electronic device 100 comprises one or a plurality of slots intended to receive SIM cards. In particular, in FIG. 1, device 100 comprises two slots 106 (SIM1) and 107 (SIM2). Slot 106 is coupled to terminal 1021 of router 102. According to an embodiment, slot 107 is coupled to terminal 1053 of secure element 105.

The operation of device 100 is the following. As previously described, device 100 is configured to implement two SIM cards and one embedded SIM card. Router 102, however, only comprises two outputs enabling it to transmit data to these SIM and embedded SIM cards. During the use of device 100, it is thus necessary to make a choice as to which SIM card and/or embedded SIM card are used. A SIM card inserted into slot 106 is always used, since it is directly coupled to the router. A SIM card inserted into slot 107 is not always used, since it is not directly coupled to router 102. The user of device 100 thus has a choice between using an embedded SIM card implemented by circuit 1051 or a SIM card inserted into slot 107.

When the user chooses to use an embedded SIM card, a method of communication between router 102 and circuit 1051 is the following. A control signal is sent to selector 1054 to indicate that circuit 1051 is selected. This step may be carried out prior to the implementation of a communication. When router 102 has a data signal to transmit to circuit 1051, it transmits it by using its terminal 1022, the connection between terminal 1022 and terminal 1052, and then terminal 1052. The data signal is then transmitted by selector 1054 to circuit 1051. According to an embodiment, circuit 1051 is configured to receive data signals referenced to the first voltage level Vdd1.

When the user chooses to use a SIM card placed in slot 107, a method of communication between router 102 and slot 107 is the following. A control signal is sent to selector 1054 to indicate that slot 107 is selected. This step may be carried out prior to the implementation of a communication. When router 102 has a data signal to transmit to slot 107, it transmits it by using secure element 105, that is, terminal 1022, the connection between terminal 1022 and terminal 1052, and then terminal 1052. The data signal is then transmitted by selector 1054 to voltage level converter 1055, which converts it into a data signal referenced to a second voltage level Vdd2, different from the first voltage level Vdd1. According to an embodiment, slot 107, and a SIM card inserted therein, are configured to receive data signals referenced to the second voltage level Vdd2. The new data signal is then transmitted by using terminal 1053 and the link between terminal 1053 and the slot.

According to an example, the links between terminals 1022, 1021, 1052, 1053 and slots 106 and 107 are links using communication protocols according to the ISO7816 standard.

According to an example, device 100 may further comprise a voltage level converter arranged between terminal 1021 of router 102 and slot 106. This converter would enable to convert (for example, adjust or level shift) the voltage levels of a signal delivered by router 102 for slot 107.

An advantage of this embodiment is that directly integrating to secure element 105 a selector and converter of the type of selector 1054 and of converter 1055 enables to make device 100 more compact.

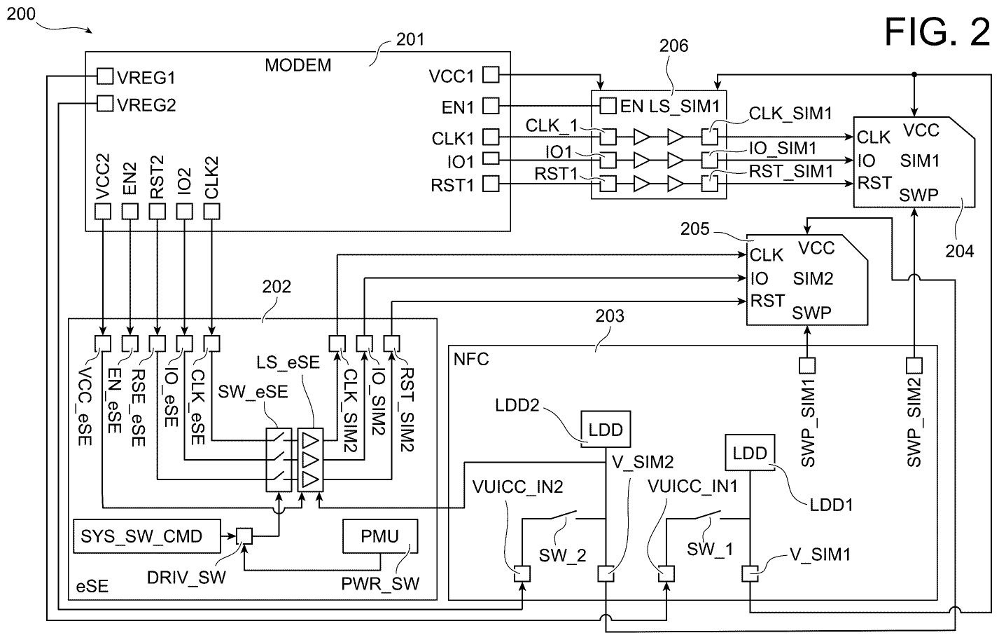

FIG. 2 shows in further detail an embodiment of an electronic device 200 of the type of the electronic device 100 described in relation with FIG. 1.

Like device 100, electronic device 200 comprises: a router 201 (Modem) of the type of the router 101 of FIG. 1; a chip comprising an embedded secure element 202 (eSE), of the type of the embedded secure element 105, and an NFC controller 203 (NFC) of the type of the NFC controller 104 of FIG. 1; two slots 204 (SIM1) and 205 (SIM2) configured to receive SIM cards, of the type of the slots 106 and 107 of FIG. 1; and a voltage level converter 206 (LS_SIM1) coupling router 201 to slot 204.

Router 201 comprises two series of communication terminals, each series of communication terminals being dedicated to delivering signals to a SIM card or an embedded SIM card, and two power terminals VREG1 and VREG2. Each series of communication terminals comprises: a power supply terminal VCC1, VCC2 delivering a power supply voltage enabling to reference the data signals; an enable terminal EN1, EN2 delivering an enable signal; a reset terminal RST1, RST2 delivering a reset signal; a communication terminal IO1, IO2 delivering a data communication signal; and a clock terminal CLK1, CLK2 delivering a clock signal.

Embedded secure element 202 comprises a circuit configured to implement an embedded SIM card, not shown in FIG. 2, a selector, a voltage level converter LS_eSE, and communication terminals.

The communication terminals of secure element 202 are the following: a power supply terminal VCC_eSE coupled, preferably connected, to the power supply terminal VCC2 of router 101; an enable terminal EN_eSE coupled, preferably connected, to the enable terminal EN2 of router 101; a reset terminal RST_eSE coupled, preferably connected, to the reset terminal RST2 of router 101; a communication terminal IO_eSE coupled, preferably connected, to the communication terminal IO2 of router 101; a clock terminal CLK_eSE coupled, preferably connected, to the clock terminal CLK2 of router 101; a clock terminal CLK_SIM2 configured to deliver a clock signal to slot 205; a communication terminal IO_SIM2 configured to deliver a data signal to slot 205; and a reset terminal RST_SIM2 configured to deliver a reset signal to slot 205.

The selector of secure element 202 comprises switches SW-eSE controlled by a driver circuit DRIV-eSE receiving a control signal DRIV_SW from a control circuit SYS_SW_CMD and powered by a power supply circuit PWR_SW (PMU). In the example of FIG. 2, switches SW_eSE are three (3) in number, and each comprise an input coupled, preferably connected, respectively to terminals RST_eSE, IO_eSE, and CLK_eSE. The outputs of switches SW-eSE are coupled, preferably connected, to inputs of voltage level converter LS_eSE.

As previously described, the selector enables to direct the data signals received from router 201 and intended for a SIM card or an embedded SIM card, and to transmit them to the SIM card or to the embedded SIM card according to a control signal. In the case illustrated herein, control circuit SYS_SW_CMD may be a processor of element 202.

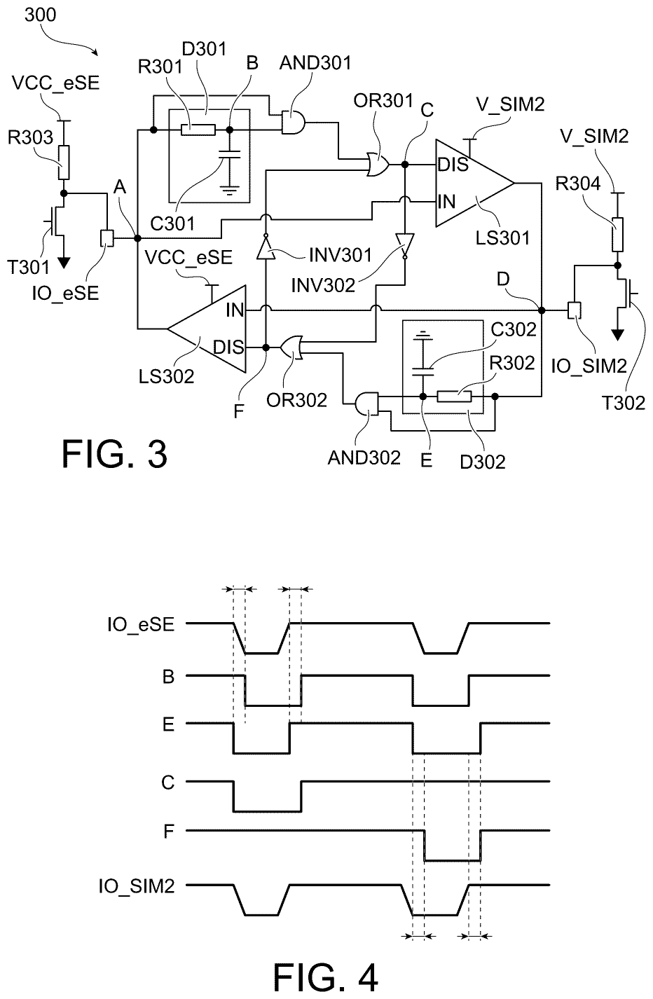

According to an embodiment, voltage level converter LS_eSE comprises as many inputs as switch SW_eSE comprises outputs. Here, voltage level converter LS_eSE comprises three inputs and three outputs. Each output of converter LS_eSE is coupled, preferably connected, to one of the communication terminals CLK_SIM2, IO_SIM2, and RST_SIM2 of secure element 202. Converter LS_eSE further comprises two power supply terminals, one receiving the power supply voltage delivered by the power supply terminal VCC_eSE corresponding to a first voltage level, of the type of the first voltage level Vdd1 described in relation with FIG. 1, and the other receiving a second power supply voltage corresponding to a second voltage level, of the type of the second voltage level Vdd2 described in relation with FIG. 1. It should be noted that the portion of converter LS_eSE converting the voltage level of the data signal transmitted by terminal IO_eSE is bidirectional. A detailed example of converter LS_eSE and its operation are described in relation with FIGS. 3 and 4.

As previously described, voltage level converter LS_eSE enables to convert the voltage levels of the data signals delivered by router 201 before transmitting them to slot 205.

NFC controller 203 is here used to communicate with slots 204 and 205, but also to convey the power supply voltages delivered by the terminals VREG1 and VREG2 of router 201, or by NFC controller 203 as described hereafter. For this purpose, NFC controller 203 comprises two communication terminals SWP_SIM1 and SWP_SIM2 configured to deliver a communication signal to slots 204 and 205.

To deliver the power supply voltages, NFC controller 203 comprises two power supply reception terminals VUICC_IN1 and VUICC_IN2, two switches SW_1 and SW_2, two voltage regulators LDO1 (LDO) and LDO2 (LDO), and two power supply transmission terminals V_SIM1 and V_SIM2. Terminal VUICC_IN1, respectively VUICC_IN2, is coupled, preferably connected, to the terminal VREG1, respectively VREG2, of router 201. Switch SW_1, respectively SW_2, comprises a first conduction terminal coupled, preferably connected, to terminal VUICC_IN1, respectively VUICC_IN2, and a second conduction terminal coupled, preferably connected, to terminal V_SIM1, respectively V_SIM2. An output of voltage regulator LDO1, respectively LDO2, is coupled, preferably connected, to terminal V_SIM1, respectively V_SIM2.

Slots 204 and 205 each comprise five terminals, among which: a terminal VCC configured to receive a power supply voltage; a terminal CLK configured to receive a clock signal; a terminal IO configured to receive a data signal and to delivering a data signal; a terminal RST configured to receive a reset signal; and a terminal SWP configured to receive a data signal and to delivering a data signal.

According to an embodiment, the terminals of slot 205 are coupled as follows: terminal VCC is coupled, preferably connected, to the terminal V_SIM2 of NFC controller 203; a terminal CLK is coupled, preferably connected, to the terminal CLK_SIM2 of embedded secure element 202; a terminal IO is coupled, preferably connected, to the terminal IO_SIM2 of embedded secure element 202; a terminal RST is coupled, preferably connected, to the terminal RST_SIM2 of embedded secure element 202; and a terminal SWP is coupled, preferably connected, to the terminal SWP_SIM2 of NFC controller 203.

Voltage level converter 206 is used to adapt or adjust the voltage levels of signals delivered by router 201 to slot 204. For this purpose, converter 206 comprises the following terminals: an enable terminal EN coupled, preferably connected, to the terminal EN1 of router 201; an input clock terminal CLK1 coupled, preferably connected to the terminal CLK1 of router 201; an input communication terminal IO1 coupled, preferably connected to the terminal IO1 of router 201; an input reset terminal RST1 coupled, preferably connected, to the terminal RST1 of router 201; an output clock terminal CLK-SIM1 coupled, preferably connected, to the terminal CLK of slot 204; an output communication terminal IO_SIM1 coupled, preferably connected to the terminal IO of slot 204; and an output reset terminal RST_SIM1 coupled, preferably connected, to the terminal RST of slot 204.

Converter 206 comprises a plurality of voltage step-up circuits coupling its input and output terminals.

According to an embodiment, the terminals of slot 204 are connected as follows: terminal VCC is coupled, preferably connected, to the terminal V_SIM1 of NFC controller 203; a terminal CLK is coupled, preferably connected, to the terminal CLK_SIM1 of voltage level converter 206; a terminal IO is coupled, preferably connected, to the terminal IO_SIM1 of voltage level converter 206; a terminal RST is coupled, preferably connected, to the terminal RST_SIM1 of voltage level converter 206; and a terminal SWP is coupled, preferably connected, to the terminal SWP_SIM1 of NFC controller 203.

The operation of device 200 is identical to the operation of the device 100 described in relation with FIG. 1.

FIG. 3 is a circuit diagram of a portion of a voltage level converter 300 of the type of the voltage level converter LS_eSE described in relation with FIG. 2. More particularly, FIG. 3 illustrates the portion of converter 300 enabling to convert the data signal delivered by terminal IO_eSE into the data signal delivered by the terminal IO_SIM2 of embedded secure element 202.

Converter 300 comprises two branches. A first branch enables to convert the voltage level of a first data signal received on terminal IO_eSE to deliver a second data signal on terminal IO_SIM2. A second branch enables to convert the voltage level of a third data signal received on terminal IO_SIM2 to deliver a fourth data signal on terminal IO_eSE.

The first branch includes a delay element D301 comprising a resistor R301 and a capacitor C301. A first terminal of resistor R301 is coupled, preferably connected, to a node A, itself coupled to terminal IO_eSE. A second terminal of resistor R301 is coupled, preferably connected, to a node B. A first terminal of capacitor C301 is coupled, preferably connected, to node B, and a second terminal of capacitor C301 is coupled, preferably connected, to a node receiving the reference potential.

The first branch further comprises a logic gate AND301 of “AND” type and a logic gate OR301 of “OR” type. A first input of gate AND301 is coupled, preferably connected, to node A, and a second input of gate AND301 is coupled, preferably connected, to node B. An output of gate AND301 is coupled, preferably connected, to a first input of gate OR301. An output of gate OR301 is coupled, preferably connected, to a node C.

The first branch further comprises a voltage level step-up circuit LS301, or boost circuit. Boost circuit LS301 comprises an input DIS coupled, preferably connected, to node C, and an input IN coupled, preferably connected, to node A. A power supply terminal of the step-up circuit is coupled, preferably connected, to the node receiving voltage V_SIM2. An output of step-up circuit LS301 is coupled, preferably connected, to node D.

The second branch comprises a delay element D302 comprising a resistor R302 and a capacitor C302. A first terminal of resistor R302 is coupled, preferably connected, to node D. A second terminal of resistor R302 is coupled, preferably connected, to a node E. A first terminal of capacitor C302 is connected, preferably connected, to node E, and a second terminal of capacitor C302 is coupled, preferably connected, to the node receiving the reference potential.

The second branch further comprises a logic gate AND302 of “AND” type and a logic gate OR302 of “OR” type. A first input of gate AND302 is coupled, preferably connected, to node D, and a second input of gate AND302 is coupled, preferably connected, to node E. An output of gate AND302 is coupled, preferably connected, to a first input of gate OR302. An output of gate OR302 is coupled, preferably connected, to a node F.

The second branch further comprises a voltage level step-up circuit LS302, or boost circuit LS302. According to an embodiment, boost circuit LS302 is identical to boost circuit LS301. Boost circuit LS302 comprises an input DIS coupled, preferably connected, to node F, and an IN input coupled, preferably connected, to node D. A power supply terminal of the boost circuit is coupled, preferably connected, to the node receiving voltage V_SIM2. An output of boost circuit LS302 is coupled, preferably connected, to a node A.

Converter 300 further comprises two logic gates INV301 and INV302 of inverting (NOT) type. An input of gate INV301 is coupled, preferably connected, to the input DIS of boost circuit LS302, and an output of gate INV301 is coupled, preferably connected, to a second input of gate OR301. An input of gate INV302 is coupled, preferably connected, to the input DIS of boost circuit LS301, and an output of gate INV302 is coupled, preferably connected, to a second input of gate OR302.

Converter 300 further comprises a pull-up resistor R303 and a transistor T301 enabling to set the voltage level of terminal IO_eSE. Resistor R303 comprises a first terminal coupled, preferably connected, to power supply terminal VCC_eSE, and a second terminal coupled, preferably connected, to terminal IO_eSE. A first conduction terminal of transistor T301 is coupled, preferably connected, to terminal IO_eSE, and a second conduction terminal of transistor T302 is coupled, preferably connected, to a node receiving a reference potential, for example the ground. According to an example, a control terminal of transistor T301 is left floating. According to an example, transistor T301 is a metal-oxide-semiconductor field-effect transistor, or MOSFET transistor, or MOS transistor. Further, transistor T301 is an N-channel MOS transistor, or N-type MOS transistor, or NMOS transistor.

Converter 300 further comprises a pull-up resistor R304 and a transistor T302 for setting the voltage level at the IO_SIM2 terminal. Resistor R304 comprises a first terminal coupled, preferably connected, to power supply terminal VCC_SIM2, and a second terminal coupled, preferably connected, to terminal IO_SIM2. A first conduction terminal of transistor T302 is coupled, preferably connected, to terminal IO_SIM2, and a second conduction terminal of transistor T302 is coupled, preferably connected, to a node receiving a reference potential, for example the ground. According to an example, a control terminal of transistor T302 is left floating. According to an example, transistor T302 is an NMOS transistor.

The operation of voltage level converter 300 is described in relation with FIG. 4.

FIG. 4 comprises timing diagrams illustrating the operation of the voltage level converter 300 described in relation with FIG. 3.

More particularly, FIG. 4 shows the time variation of the following data signals: a signal IO_eSE representing the variation of the data signal present at terminal IO_eSE; a signal B representing the variation of the data signal present at node B; a signal E representing the variation of the data signal present at node E; a signal C representing the variation of the data signal present at node C; a signal F representing the variation of the data signal present at node F; and a signal IO_SIM2 representing the variation of the data signal present at terminal IO_SIM2.

As soon as signal IO_eSE exhibits a falling edge, signals E, C, and IO_SIM2 all immediately exhibit a falling edge, and signal F if not modified. Signal B also exhibits a falling edge, delayed by delay element D301. However, when signal IO_eSE exhibits a rising edge, signals B, E, C, and IO_SIM2 all exhibit a rising edge with a delay defined by delay element D301, and signal F is not modified.

Conversely, as soon as signal IO_SIM2 exhibits a falling edge, signals B, E, and IO_eSE all immediately exhibit a falling edge, and signal C is not modified. Signal F also exhibits a falling edge, delayed by delay element D301. However, when signal IO_SIM2 exhibits a rising edge, signals B, E, F, and IO_eSE all exhibit a rising edge with a delay defined by delay element D301, and signal C is not modified.

An advantage of voltage level converter 300 is that the presence of the delay elements D301 and D302 enable to obtain a bidirectional converter, that is, a converter capable of converting the voltage level of a signal arriving onto terminal IO_eSE and also of a signal arriving onto terminal IO_SIM2. Without the presence of delay elements D301 and D302, no data would be transmitted.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. An embedded secure element, comprising:
an input configured to receive at least a first data signal;
a circuit configured to implement an embedded SIM card;
an output configured to deliver a second signal;
a first voltage level converter configured to deliver said second signal to said output; and
a selector configured to receive said first signal and to deliver the received first signal to said circuit in response to a first state of a control signal and deliver the received first signal to the first voltage level converter to generate the second signal in response to a second state of the control signal.

2. The element according to claim 1, wherein said output is configured to deliver said second signal to a first slot intended to receive a first SIM card.

3. The element according to claim 1, wherein said first voltage level converter is bidirectional.

4. The element according to claim 3, wherein said first voltage level converter comprises:
an input node;
an output node;
a first branch, coupling said input node to said output node, comprising a first delay circuit and a first voltage level step-up circuit; and
a second branch, coupling the output node to said input node, comprising a second delay circuit and a second voltage level step-up circuit.

5. A chip, comprising: the embedded secure element according to claim 1.

6. The chip according to claim 5, further comprising a near-field communication controller.

7. An electronic device, comprising:
the chip according to claim 5; a router; and
said first slot.

8. The device according to claim 7, further comprising a second slot intended for a second SIM card.

9. The device according to claim 8, further comprising a second voltage level converter coupling said router and said second slot.

10. The device according to claim 7, wherein the device is a cell phone.

11. The device according to claim 7, further comprising a control circuit configured to control communication within the device between said router and said first slot.

12. The device according to claim 11, wherein the control circuit is configured to control:
sending a control signal to said selector indicating that said first slot is selected;
sending, by use of said router, said first voltage to the input of said embedded secure element;
converting said first voltage, by use of said first voltage level converter, into said second voltage; and
sending, by use of said embedded secure element, said second voltage to said first slot.
